(19) United States
(12) Patent Application Publication
(10) Pub. No.: US 2005/0154997 A1
(43) Pub. Date: Jul. 14, 2005

(54) Methods and systems for accessing and selecting data items utilizing graphically displayed iconettes

(75) Inventors: Francoise Brun-Cottan, West Hollywood, CA (US); Andrea Mosher, Victor, NY (US); Patricia L. Swenton-Wall, Victor, NY (US); David L. Lindahl JR., Rochester, NY (US); Nelson G. Mejias-Diaz, Toa Baja, PR (US)

Correspondence Address: Ortiz & Lopez, PLLC, P.O. Box 4484, Albuquerque, NM, 87196-4484, US

(73) Assignee: Xerox Corporation

(21) Appl. No.: 10/756,988

(22) Filed: Jan. 13, 2004

(51) Int. Cl. G06F 3/00; G06F 17/21

(52) U.S. Cl. 715/805; 715/769; 715/808; 715/809; 715/810; 715/847; 715/804; 715/501.1; 715/513

(57) ABSTRACT

Methods and systems for displaying data items, such as graphical icons, in association with objects containing information relative to such data items, are disclosed. In general, at least one object can be associated with a data item, wherein the object contains information relevant to the data item. A compacted view of the data item can be displayed in a location of a display screen proximate to the object, wherein a selection of the object invokes a display of information relevant to the data item. A display of information relevant to the data item can then be displayed in response to dragging a graphically displayed cursor across the object displayed on the display screen. Information relevant to the data item can be displayed in a form of a graphical pop-up window, which when selected by a user activates an additional graphical window comprising further information relevant to the data item.

### TECHNICAL FIELD

Embodiments are generally related to data-processing systems and graphical user interface (GUI) environments. Embodiments are also related to methods and systems for simultaneously accessing data items, such as digital images, and information relevant to such data items.

### BACKGROUND OF THE INVENTION

Users of digital image collections need to be able to view, sort and organize digital images for use in presentations, lectures papers, reports, online training modules, distance learning classes, and the like. Such digital image collections can number from a few images to tens of thousands of images. Obtaining information relevant to the images, such as copyright, permissions, licenses, royalties and the like is generally a clumsy, confusing and time-consuming effort. The ability to obtain and simultaneously view information about multiple images in order to enable appropriate and efficient image selection and uses therefore is not supported by present applications.

Increasingly, users are able to retrieve images from multiple databases and collections, which are created and owned by different rights holders. This means that the permissions and costs for using such images may vary across collections, even for the same image. Clearly, the selection of one particular image from one source, rather than another, may be predicated on their varying copyrights and costs, as well as the quality of the image itself. Currently, users are unable to directly, from the a search results screen either accept conditions for permissions of use or accept terms of payment and charges for ordering and using the image.

As an increasing number of digital image collections are becoming available through individual servers, digital storage media (e.g., CD-ROM, DVD, etc.) or online via, for example, the well-known “World Wide Web”, the potential to access and utilize the images is enormous to both for-profit and non-profit contexts. Users should have, but presently are not offered, the ability to make full user of digital presentation contexts. Markets where such activities are particularly useful include engineering and architectural firms, document warehouses, publishing and graphics industries, catalog retailers, parts and materials divisions of manufacturers, educational institutions, and libraries and museums.

In an effort to minimize file size and transfer time, images are often displayed in thumbnail format. The thumbnails may appear one to a page, in a list context, or as a matrix of such thumbnails. Thumbnails are often presented along with various amounts of textual data (e.g., metadata) that describe the image. Searches resulting in multiple “hits” can be displayed in contact sheets or “digital slide sleeves” that can hold a number of digital images. The ability to view multiple images “at a glance” is of the great advantages of such a view. In addition, listing or displaying the textual metadata information simultaneously with the images in slide sleeve views can result in obscuring of many of the images, which presents a screen real estate issue that must be resolved in order to accommodate basic display screen sizes, as well as those of larger monitors.

Users need to know information about the image that pertains to its display and user (e.g., copyrights, permissions, file size, format, royalties, and other costs or conditions of use. In order to find and displays such information, users are often required to search through application or database and may be forced to leave the screen on which the relevant images are displayed. This is time consuming and can be confusing. In instances where multiple images are under consideration, it is even more difficult to track which image any specific block of metadata refers.

Users' decisions, however, to employ or purchase an image may be influenced by the aforementioned types of information. Databases, especially for libraries and higher education institutions and distance learning providers, can become filled with images from heterogeneous sources. Varying rights holders and commercial vendors may provide different use and cost requirements, which also complicates access issues for users. A simplified method and system is therefore needed for displaying relevant information, and which would additionally allow users to identify conditions of use and sots and other pertinent information about an image without leaving the screen in which the image is displayed.

### BRIEF SUMMARY

It is, therefore, a feature of the present invention to provide for an improved method and system for retrieving and organizing data displayed within graphical user interface (GUI) environments.

It is another feature of the present invention to provide for improved methods and systems for automatically and simultaneously viewing an icon and information relative to the icon in order to enhance image selection thereof.

Aspects of the present invention relate to methods and systems for displaying data items, such as graphical icons, in association with objects containing information relative to such data items. In general, at least one object can be associated with a data item, wherein the object contains information relevant to the data item. A compacted view of the data item can be displayed in a location of a display screen proximate to the object, wherein a selection of the object invokes a display of information relevant to the data item. A display of information relevant to the data item can then be displayed in response to dragging a graphically displayed cursor across the object displayed on the display screen. Information relevant to the data item can be displayed in a form of a graphical pop-up window, which when selected by a user activates an additional graphical window comprising further information relevant to the data item. Such an additional graphical window can comprise an interactive region for initiating user transactions thereof. The objects themselves can be implemented as graphical iconettes displayable on the display screen.

### BRIEF DESCRIPTION OF THE DRAWINGS

The accompanying figures, in which like reference numerals refer to identical or functionally-similar elements throughout the separate views and which are incorporated in and form part of the specification further illustrate embodiments of the present invention.

FIG. 1 illustrates a pictorial representation of a computer system in which a preferred embodiment of the present invention can be implemented;

FIG. 2 illustrates a block diagram of a representative hardware environment of the processing unit of the computer system depicted in FIG. 1;

FIG. 3 illustrates a block diagram of software stored within the memory of the computer system illustrated in FIG. 1;

FIG. 4 illustrates a graphical representation of one or more iconettes, a pop-up window and an inconette information window, which may be implemented in accordance with a preferred embodiment of the present invention;

FIG. 5 illustrates a high-level flow chart depicting logical operational steps, which may be implemented in accordance with a preferred embodiment of the present invention;

### DETAILED DESCRIPTION OF THE INVENTION

The particular values and configurations discussed in these non-limiting examples can be varied and are cited merely to illustrate embodiments of the present invention and are not intended to limit the scope of the invention.

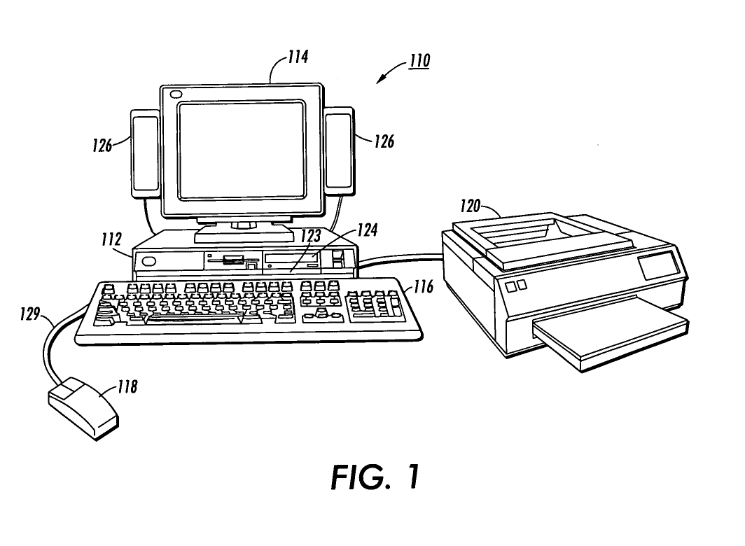

With reference now to the figures and in particular with reference to FIG. 1, there is depicted an embodiment of a computer system that can be utilized to implement the preferred embodiment. Data-processing system 110 includes processing unit 112, display device 114, keyboard 116, pointing device 118, printer 120, and speakers 126. Processing unit 112 receives input data from input devices such as keyboard 116, pointing device 118, and local area network interfaces (not illustrated) and presents output data to a user via display device 114, printer 120, and speakers 126.

Keyboard 116 is that part of data-processing system 110 that resembles a typewriter keyboard and that enables a user to control particular aspects of the computer. Because information flows in one direction, from keyboard 114 to processing unit 112, keyboard 116 functions as an input-only device. Functionally, keyboard 116 represents half of a complete input/output device, the output half being video display terminal 114. Keyboard 116 includes a standard set of printable characters presented in a “QWERTY” pattern typical of most typewriters. In addition, keyboard 116 includes a calculator-like numeric keypad at one side. Some of these keys, such as the “control,” “alt,” and “shift” keys can be utilized to change the meaning of another key. Other special keys and combinations of keys can be utilized to control program operations or to move either text or cursor on the display screen of video-display terminal 114.

Video-display terminal 114 is the visual output of data-processing system 110. As indicated herein, video-display terminal 114 can be a cathode-ray tube (CRT) based video display well-known in the art of computer hardware. But, with a portable or notebook-based computer, video-display terminal 114 can be replaced with a liquid crystal display (LCD) based or gas, plasma-based, flat-panel display.

Pointing device 118 is preferably utilized in conjunction with a graphical user-interface (GUI) in which hardware components and software objects are controlled through the selection and the manipulation of associated, graphical objects displayed within display device 114. Although data-processing system 110 is illustrated with a mouse for pointing device 118, other graphical-pointing devices such as a graphic tablet, joystick, track ball, touch pad, or track pad could also be utilized. Pointing device 118 features a casing with a flat bottom that can be gripped by a human hand. Pointing device 118 can include buttons on the top, a multidirectional-detection device such as a ball on the bottom, and cable 129 that connects pointing device 118 to processing unit 112.

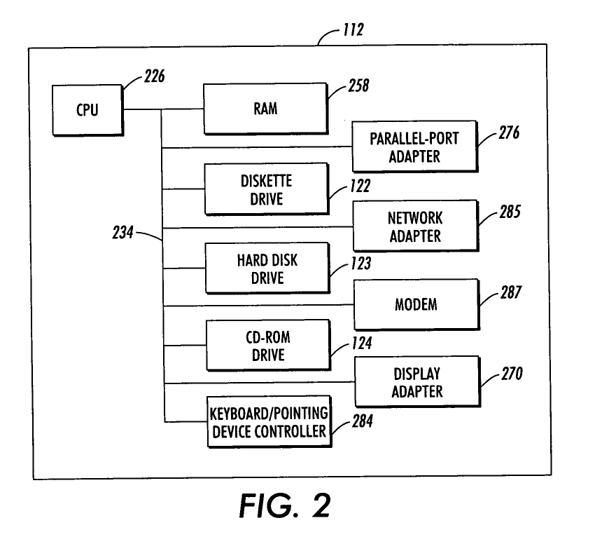

To support storage and retrieval of data, processing unit 112 further includes diskette drive 122, hard-disk drive 123, and CD-ROM drive 124, which are interconnected with other components of processing unit 112, and which are further described below under the description for FIG. 2. Data-processing system 110 can be implemented utilizing any suitable computer. But, a preferred embodiment of the present invention can apply to any hardware configuration that allows the display of windows, regardless of whether the computer system is a complicated, multi-user computing apparatus, a single-user workstation, or a network appliance that does not have non-volatile storage of its own.

Referring to FIG. 2, there is depicted a block diagram of the principal components of processing unit 112. CPU 226 is connected via system bus 234 to RAM (Random Access Memory) 258, diskette drive 122, hard-disk drive 123, CD-ROM drive 124, keyboard/pointing-device controller 284, parallel-port adapter 276, network adapter 285, display adapter 270, and modem 287. Although the various components of FIG. 2 are drawn as single entities, each may consist of a plurality of entities and may exist at multiple levels.

Processing unit 112 includes central processing unit (CPU) 226, which executes instructions. CPU 226 includes the portion of data-processing system 110 that controls the operation of the entire computer system, including executing the arithmetical and logical functions contained in a particular computer program. Although not depicted in FIG. 2, CPU 226 typically includes a control unit that organizes data and program storage in a computer memory and transfers the data and other information between the various parts of the computer system. CPU 226 generally includes an arithmetic unit that executes the arithmetical and logical operations, such as addition, comparison, and multiplication. CPU 226 accesses data and instructions from and stores data to volatile RAM 258.

CPU 226 can be implemented, for example, as any one of a number of processor chips, or any other type of processor, which are available from a variety of vendors. Although data-processing system 110 is shown to contain only a single CPU and a single system bus, the present invention applies equally to computer systems that have multiple CPUs and to computer systems that have multiple buses that each performs different functions in different ways.

RAM 258 comprises a number of individual, volatile-memory modules that store segments of operating system and application software while power is supplied to data-processing system 110. The software segments are partitioned into one or more virtual-memory pages that each contains a uniform number of virtual-memory addresses. When the execution of software requires more pages of virtual memory than can be stored within RAM 258, pages that are not currently needed are swapped with the required pages, which are stored within non-volatile storage devices 122 or 123. RAM 258 is a type of memory designed such that the location of data stored in it is independent of the content. Also, any location in RAM 258 can be accessed directly without needing to start from the beginning.

Hard-disk drive 123 and diskette drive 122 are electromechanical devices that read from and write to disks. The main components of a disk drive are a spindle on which the disk is mounted, a drive motor that spins the disk when the drive is in operation, one or more read/write heads that perform the actual reading and writing, a second motor that positions the read/write heads over the disk, and controller circuitry that synchronizes read/write activities and transfers information to and from data-processing system 110.

A disk itself is typically a round, flat piece of flexible plastic (e.g., floppy disk) or inflexible metal (e.g. hard disk) coated with a magnetic material that can be electrically influenced to hold information recorded in digital form. A disk is, in most computers, the primary method for storing data on a permanent or semi permanent basis. Because the magnetic coating of the disk must be protected from damage and contamination, a floppy disk (e.g., 5.25 inch) or micro-floppy disk (e.g., 3.5 inch) is encased in a protective plastic jacket. But, any size of disk could be used. A hard disk, which is very finely machined, is typically enclosed in a rigid case and can be exposed only in a dust free environment. Keyboard/pointing-device controller 284 interfaces processing unit 112 with keyboard 116 and graphical-pointing device 118. In an alternative embodiment, keyboard 116 and graphical-pointing device 118 have separate controllers. Display adapter 270 can translates graphics data from CPU 226 into video signals utilized to drive display device 114.

Finally, processing unit 112 includes network adapter 285, modem 287, and parallel-port adapter 276, which facilitate communication between data-processing system 110 and peripheral devices or other computer systems. Parallel-port adapter 276 transmits printer-control signals to printer 120 through a parallel port. Network adapter 285 connects data-processing system 110 to an un-illustrated local area network (LAN). A LAN provides a user of data-processing system 110 with a means of electronically communicating information, including software, with a remote computer or a network logical-storage device. In addition, a LAN supports distributed processing, which enables data-processing system 110 to share a task with other computer systems linked to the LAN., which can also be implemented in the context of a wireless local area network (WLAN).

Modem 287 supports communication between data-processing system 110 and another computer system over a standard telephone line. Furthermore, through modem 287, data-processing system 110 can access other sources such as a server, an electronic bulletin board, and the Internet or the well-known World Wide Web.

The configuration depicted in FIG. 1 is but one possible implementation of the components depicted in FIG. 2. Portable computers, laptop computers, and network computers or Internet appliances are other possible configurations. The hardware depicted in FIG. 2 may vary for specific applications. For example, other peripheral devices such as optical-disk media, audio adapters, or chip-programming devices, such as PAL or EPROM programming devices well-known in the art of computer hardware, may be utilized in addition to or in place of the hardware already depicted.

As will be described in detail below, aspects of the preferred embodiment pertain to specific method steps implementable on computer systems. In an alternative embodiment, the invention may be implemented as a computer program-product for use with a computer system. The programs defining the functions of the preferred embodiment can be delivered to a computer via a variety of signal-bearing media, which include, but are not limited to, (a) information permanently stored on non-writable storage media (e.g., read-only memory devices within a computer such as CD-ROM disks readable by CD-ROM drive 124); (b) alterable information stored on writable storage media (e.g., floppy disks within diskette drive 122 or hard-disk drive 123); or (c) information conveyed to a computer by a communications media, such as through a computer or telephone network, including wireless communications. Such signal-bearing media, when carrying computer-readable instructions that direct the functions of on or more embodiments present invention, and/or represent alternative embodiments of the present invention.

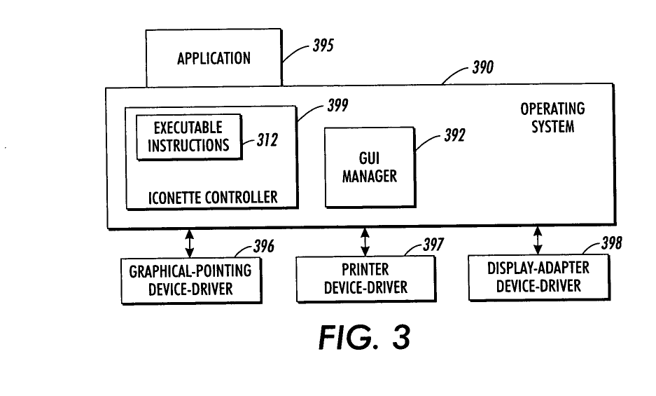

With reference now to FIG. 3, there is illustrated a block-diagram representation of the software configuration of data-processing system 110. As noted above, the software executed by data-processing system 110 can be stored within one or more of RAM 258, the nonvolatile storage provided by diskette drive 122, hard-disk drive 123, CD-ROM drive 124, or a remote server accessible via modem 287 or network adapter 285.

As illustrated, the software configuration of data-processing system 110 includes operating system 390, which is responsible for directing the operation of data-processing system 110. For example, operating systems typically include computer software for controlling the allocation and usage of hardware resources such as memory, CPU time, disk space, and peripheral devices. Other technologies also could be utilized, such as touch-screen technology or human-voice control. The operating system is the foundation upon which applications 395, such word-processing, spreadsheet, and web-browser programs are built.

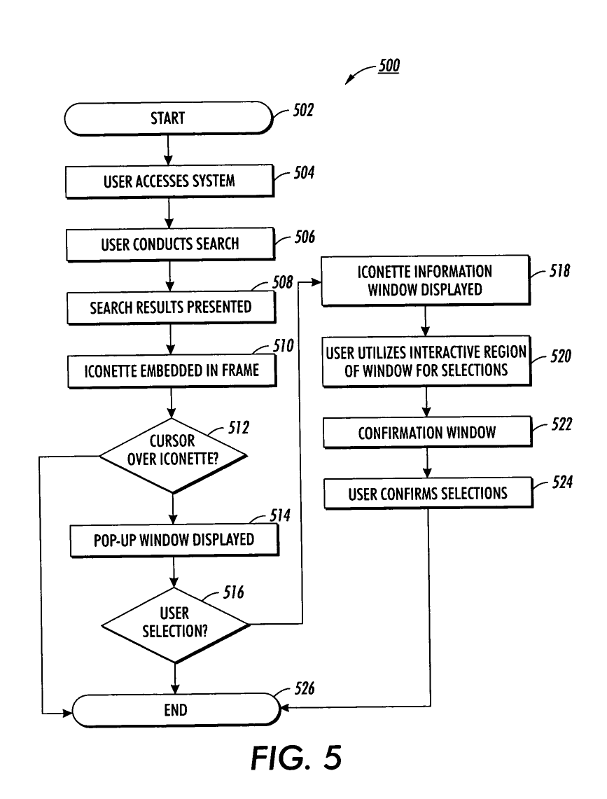

In accordance with the preferred embodiment, operating system 390 includes graphical-user-interface (GUI) 392 manager although they could be packaged separately. GUI 392 manages the graphical user-interface with which a user of data-processing system 110 interacts. Operating system 390 also includes iconette controller 399. Iconette controller 399 contains executable instructions 312. Although iconette controller 399 is drawn as being included in operating system 390, inconette controller 399 could be packaged separately from operating system 390. Referring again to FIG. 3, CPU 226 is suitably programmed to carry out the preferred embodiment by executable instructions 312, as described in more detail in the flowcharts of FIG. 5. In the alternative, the functions of FIG. 5 can be implemented by control circuitry through the use of logic gates, programmable-logic devices, or other hardware components in lieu of a processor-based system.

Operating system 390 communicates with applications 395 through messages conforming to the syntax of the application-program interface (API) supported by operating system 390. Operating system 390 further communicates with graphical-pointing device-driver 396, printer device-driver 397, and display-adapter device-driver 398. For example, operating system 390 sends graphics data to display-adapter device-driver 398, which in turn translates the messages into bus signals utilized to control display adapter 270. In addition, graphical-pointing device-driver 396 translates signals from pointing device 118 through keyboard/pointing-device controller 284 into Cartesian coordinates and a selection status, which are then relayed to GUI manager 392. Also, operating system 390 sends printer-control codes and data to printer device-driver 397, which in turn translates the control codes and data into bus signals used to control printer 120.

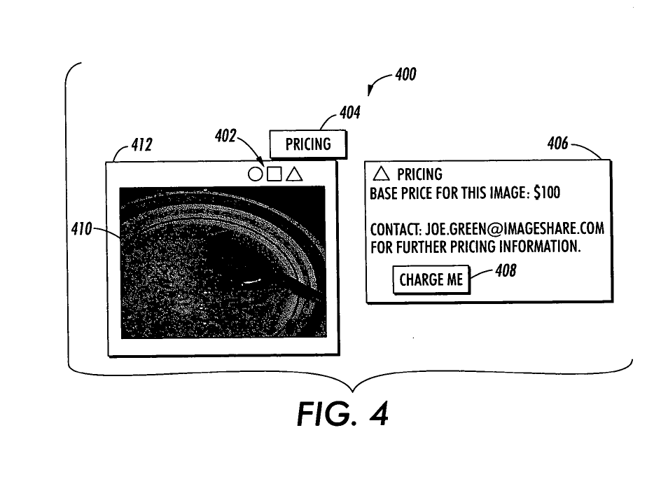

FIG. 4 illustrates a graphical representation of a system 400 that includes one or more iconettes, a pop-up window and an inconette information window, which may be implemented in accordance with a preferred embodiment of the present invention. System 400 includes a plurality of iconette symbols (also referred to simply as “iconettes), which are located proximate to an icon 410 within a frame or framed region 412 that surrounds icon 410. Icon 410 comprises a small image that can be displayed on a display screen of a data-processing system, such as for example, data-processing system 110 of FIG. 1. Note that the term “window” as utilized herein generally refers to that portion of the screen, in graphical interfaces such as GUIs that can contain its own document or message. In window-based graphical user interface environments, a GUI screen can be subdivided into one or more windows, each of which contain its own boundaries and additionally can comprise one or more varying documents or views.

Icon 410 represents a data item that can be manipulated by a user. By providing visual mnemonics, a user is permitted to control certain data-processing system actions without having to recall commands or input such commands via user input device such as a computer keyboard. Examples of data items which can be represented graphically as icons include data items such as JPEG, MPEG, word processing files, spreadsheet files, text format files, and the like. One or more objects or “iconettes” 402 are associated with an individual data item, such as icon 410. Such objects or iconettes 402 contain information relevant to the data item or icon 410. The icon 410 is a compacted view the data item. A selection of one or more of the objects (i.e., iconettes 402) by a user can invoke a display of information relevant to the data item, which is indicated initially by a pop-up window 404 and more detailed information displayed within an iconette information window 406 that includes an interactive region 408.

In general, a user interface (e.g., GUI) for viewing images presented in image and text format can be enhanced by the creation of objects such as iconettes 402 or “hot areas” embedded within individual image frames or borders. In an effort to minimize file size and transfer time, images are often displayed in thumbnail format. When a user retrieves a thumbnail image or a set of thumbnail images as the result of a search or other data-processing system event initiated by the user, such images can be displayed in a visible “thumbnail” frame. Small color-coded icons or “iconettes” can then be displayed in the space between the edge of the thumbnails and the outer edge of the frame. When a cursor passes or runs over an individual iconette 402, a title name the information the iconette can reveal is displayed within pop-up window 404. Iconette information window 408 can be displayed in association with the display of pop-up window 404 or as a result of an additional user input. In either case, the use of an iconette and a pop-up window permits a user to select options pertaining to the use of the image directly from image itself

FIG. 5 illustrates a high-level flow chart 500 depicting logical operational steps, which may be implemented in accordance with a preferred embodiment of the present invention. As depicted at block 502, the iconette process is initiated. Thereafter, as illustrated at block 504, a user can access a data-processing system, which utilizes iconettes as indicated herein by, for example, providing credentials authorization (e.g., log-in password).

A user may wish, for example, to conduct an online search via a so-called “search engine”. Note that as utilized herein, the term “search engine” generally refers to a type of program, routine and/or subroutine that searches documents for specified keywords provided by the user and returns a list of the documents or pages where (e.g., Web pages) the keywords were found. A user may, for example, be required to provide his or credit card account information so that such an account can be credited in return for accessing such a search engine via an online Web site. Instead of using a search engine, a user can simply user a scaled-down version of a search engine which permits a user to search specific types of databases. For example, a user may wish to access a “Web site” which provides thousands of photographs in the form of digital images. The user can manually scroll through indexes by photograph subject or may access a scaled down search engine which utilizes keywords or phrases provided by the user to search for particular types of photographs or photographs by the names of the photographer, year the image was first captured, country or state of origin, and so forth.

When the user has successfully been approved to access a particular database, the user may conduct a search of the database via the search engine, as illustrated at block 506. Thereafter, as indicated at block 508, the search results (e.g., documents, images, Web pages, text, and the like) can be graphically presented to the user via a display screen. As indicated next at block 510, each search result is associated with iconette symbols (i.e., iconettes), which are embedded in a frame surrounding the search result icon. The iconettes can represent various functions such as, for example, copyright notices, user permissions, pricing information, and the like. Thereafter, as indicated at block 512, if a user rolls a graphically displayed cursor over an iconette symbol, then as indicated at block 514, a pop-up window “pops” up to display the values of the fields that the iconette represents.

Selecting (e.g., “clicking”) an iconette, as indicated at block 516 can display an iconette information window, as indicated thereafter at block 518. An example of such an iconette information window is window 406 of FIG. 4. The user can then select desired options in the interactive region 408 of the iconette information window 406 as described at block 520. Examples of selection options which may be displayed within the interactive region of the iconette information window include graphically displayed check boxes, radio buttons, and other GUI buttons. Thereafter, as indicated at block 522, a confirmation window can be automatically implemented, in response to user selections via the iconette information window. As indicated at block 524, if the user confirms selections, information can be sent to an asset management and tracking service to finalize a user selection of the data item associated with the icon that is responsive to the iconette originally selected (i.e., see blocks 512 and 514). The process can then terminate as indicated at block 526.

The process depicted in flow chart 500 can be embodied as one or more modules. Note that embodiments described herein can be implemented in the context of a “module” or a group of such modules. In the computer programming arts, a module can be typically implemented as a collection of routines and data structures that performs particular tasks or implements a particular abstract data type.

Modules generally are composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media. Flow chart 500 of FIG. 5 can therefore be implemented as a module or group of such modules.

An example of a type of module (i.e., software module), which can be implemented in accordance with embodiments of the present invention is a display module. As indicated herein, one or more objects or iconettes can be associated with a data item such as a digital image (e.g., JPEG file). The object contains or is associated with information that is relevant to the data item. A display module can be automatically through user interaction with a GUI to display a compacted view (e.g., a thumbnail) of the data item in a location of a display screen proximate to the object, wherein a selection of the object by a user can invoke a display of information relevant to the data item. A display module of this type can be programmed to invoke a display of information relevant to the data item in response to dragging a graphically displayed cursor across the object displayed on the display screen.

Another type of module which can be implemented in accordance with embodiments of the present invention is a selection module. Such a selection module can be utilized to enable a use to select the object (e.g., an iconette symbol) to invoke a display of information relevant to the data item (e.g., digital image file). Such modules can be implemented for example via executable instructions 312 associated with iconette controller 399 of FIG. 3.

It can be appreciated that various other alternatives, modifications, variations, improvements, equivalents, or substantial equivalents of the teachings herein that, for example, are or may be presently unforeseen, unappreciated, or subsequently arrived at by applicants or others are also intended to be encompassed by the claims and amendments thereto.

1. A method, comprising:
associating at least one object with a data item, wherein said at least one object contains information relevant to said data item; and
displaying a compacted view of said data item in a location of a display screen proximate to said at least one object, wherein a selection of said at least one object invokes a display of information relevant to said data item.

2. The method of claim 1 further comprising automatically invoking a display of information relevant to said data item in response to dragging a graphically displayed cursor across said at least one object displayed on said display screen.

3. The method of claim 1 further comprising selecting said at least one object to invoke a display of information relevant to said data item.

4. The method of claim 1 further comprising displaying information relevant to said data item in a form of a graphical pop-up window, which when selected by a user activates an additional graphical window comprising further information relevant to said data item.

5. The method of claim 4 wherein said additional graphical window comprises an interactive region for initiating at least one user transaction thereof.

6. The method of claim 1 further comprising configuring said at least one object as a graphical inconette displayable on said display screen.

7. The method of claim 1 wherein said data item comprises a graphical image

8. The method of claim 1 wherein displaying a compacted view of said data item in a location of a display screen proximate to said at least one object, wherein a selection of said at least one object invokes a display of information relevant to said data item, further comprises:
displaying a compacted view of a plurality of data items in a display area of a display screen, wherein at least one data item among said plurality of data items is displayed proximate to at least one object containing information relevant to said at least one data item, wherein a selection of said at least one object invokes a display of information relevant to said at least one data item.

9. The method of claim 1 wherein displaying a compacted view of said data item in a location of a display screen proximate to said at least one object further comprises:
displaying data associated with said data item as a graphical icon on said display screen; and
displaying said at least one object as an a graphical iconette embedded within a graphical frame surrounding said graphical icon, wherein said graphical iconette can be invoked by said user to display information relevant to said graphical icon.

10. A system, comprising:
at least one object associated with a data item, wherein said at least one object contains information relevant to said data item; and
display module for displaying a compacted view of said data item in a location of a display screen proximate to said at least one object, wherein a selection of said at least one object invokes a display of information relevant to said data item.

11. The system of claim 10 further comprising a graphical user interface, wherein said display module displays said compacted view of said data item within said graphical user interface within said display screen and wherein a user can invoke said display.

12. The system of claim 10 further wherein said display module invokes a display of information relevant to said data item in response to dragging a graphically displayed cursor across said at least one object displayed on said display screen.

13. The system of claim 10 further comprising selection module for selecting said at least one object to invoke a display of information relevant to said data item.

14. The system of claim 10 wherein said display module displays information relevant to said data item in a form of a graphical pop-up window, which when selected by a user activates an additional graphical window comprising further information relevant to said data item.

15. The system of claim 14 wherein said additional graphical window comprises an interactive region for initiating at least one user transaction thereof.

16. The system of claim 10 wherein said at least one object is configured as a graphical inconette displayable on said display screen.

17. The system of claim 10 wherein said data item comprises a graphical image

18. The system of claim 10 wherein said display module displays a compacted view of a plurality of data items in a display area of a display screen, wherein at least one data item among said plurality of data items is displayed proximate to at least one object containing information relevant to said at least one data item, wherein a selection of said at least one object invokes a display of information relevant to said at least one data item.

19. The system of claim 10 wherein said display module displays data associated with said data item as a graphical icon on said display screen.

20. A system, comprising:
at least one iconette associated with a data item, wherein said at least one iconette contains information relevant to said data item; and
a display module for displaying a compacted view of said data item in a location of a display screen proximate to said at least one iconette, wherein a selection of said at least one iconette invokes a display of information relevant to said data item and wherein said display module displays data associated with said data item as a graphical icon on said display screen.
